(19) United States
(12) Patent Application Publication
(10) Pub. No.: US 2025/0361083 A1
(43) Pub. Date: Nov. 27, 2025

(54) HIGH-BAY WAREHOUSE FOR EMPTY CONTAINERS

(71) Applicant: AMOVA GmbH, Hilchenbach (DE)

(72) Inventors: Volker BRÜCK, Mudersbach (DE); Bernd BÜDENBENDER, Siegen (DE)

(73) Assignee: AMOVA GmbH, Hilchenbach (DE)

(21) Appl. No.: 18/992,951

(22) PCT Filed: Jun. 28, 2023
(86) PCT No.: PCT/EP2023/067681

§ 371 Date: Jan. 9, 2025

(30) Foreign Application Priority Data
Jul. 12, 2022 (DE) 10 2022 117 327.5

(51) Int. Cl. B65G 1/04; B65G 63/00

(52) U.S. Cl. CPC B65G 1/0407; B65G 63/004; B65G 2201/0235

(57) ABSTRACT

A high bay storage system for storing and retrieving containers includes a plurality of separate rack compartments arranged horizontally next to one another and vertically one above the other, and storage aisles arranged between groups of rack compartments and extending in parallel with one another and in each of which at least one stacker crane is moveable back and forth, this stacker crane being designed to move the containers vertically and horizontally and to move them into and out of the rack compartments. The high bay storage system, in addition to the separate rack compartments, has at least one area which is designed and suitable for receiving empty containers stacked one on top of the other. A method allows for storing and retrieving and relocating containers in such a high bay storage system.

### CROSS-REFERENCE TO RELATED APPLICATION

This application is a national stage application, filed under 35 U.S.C. § 371, of International Patent Application PCT/EP2023/067681, filed on Jun. 28, 2023, which claims the benefit of German Patent Application DE 10 2022 117 327.5, filed on Jul. 12, 2022.

### TECHNICAL FIELD

The disclosure relates to a high bay storage system for storing and retrieving containers and to a method for storing and retrieving or relocating containers in such a high bay storage system.

### BACKGROUND

High bay storage (HBS) systems are well known from the prior art and are widely used in particular in transshipment facilities of seaports or inland ports. The high bay storage systems usually have a plurality of separate rack compartments arranged horizontally next to one another and vertically one above the other, and storage aisles arranged between groups of rack compartments and extending in parallel with one another and in each of which at least one stacker crane is moveable back and forth, this stacker crane being designed to move the containers vertically and horizontally and to move them into and out of the rack compartments.

One example of such a high bay storage system is disclosed in WO 2015/1243482 A1. In this high bay storage system, standard containers are picked up by a stacker crane at a transfer point within the high bay storage system and then conveyed by the stacker crane to a pre-defined rack compartment and stored in this rack compartment. The containers are grasped suspended from above and laterally inserted into the respective rack compartments by means of a telescopic system such that the longitudinal side of the container is aligned parallel to the storage aisle. This leads to maximum utilization of the space within the bay warehouse, since the storage aisles only need to be designed somewhat wider than the respective front sides of the containers.

In addition, the suspended transport of containers by means of the stacker crane and the use of a telescopic system, by means of which the container is conveyed out of the area of the storage aisle and into the desired rack compartments, enables the overall structure of the high bay storage system to be reduced. Shelves can be dispensed with entirely in the respective rack compartments, provided that it is ensured that support points for at least the corner regions of the containers are arranged in each rack compartment. These supports can preferably be arranged on vertical pillars of the high bay storage structure itself so that optimum utilization of space can be achieved coupled with the most lightweight construction of the high bay storage structure.

When transshipping containers, in particular in seaports or inland ports, not only is it necessary to store and retrieve containers filled with freight, but empty containers also need to be handled. Since, however, empty containers do not have to be stored in separate or individual rack compartments within a high bay storage system, special storage areas for empty containers are usually provided near high bay storage systems. Stacks of empty containers, usually 5-8 containers high, are formed in these storage locations, with the supply and the removal of empty containers within these special storage locations being able to be carried out by means of special vehicles suitable therefor, so-called “empty container handlers (ECH)”.

In these areas, the containers are directly stacked straight one on top of the other, new empty containers are placed on existing stacks if necessary, required empty containers are each taken from existing stacks in a circular loop fashion, without it being necessary to remove a specific container, as long as it is ensured that the desired size, type and number of containers can be provided.

The handling of empty containers, as is known to date, is rarely automated and demands more input than would be liked, both in terms of time and manpower.

### SUMMARY

The present application provides a high bay storage system and a method for storing, retrieving or relocating containers in such a high bay storage system, both of which are suitable for overcoming the problems known from the prior art and for achieving a greater degree of automation and safety and a higher throughput of empty containers per unit of time.

A high bay storage system for storing and retrieving containers is provided, which system has a plurality of storage locations arranged horizontally next to one another and vertically one above the other for containers and storage aisles which are arranged between groups or levels of storage locations and extend in parallel with one another and in each of which at least one stacker crane =is moveable back and forth, wherein this stacker crane is designed to move the containers vertically and horizontally and to move them into and out of the storage locations. Usually, such groups of storage locations are modular and extend over virtually the entire length and height of the bay warehouse. The storage locations are preferably provided as separately arranged rack compartments and can thus also be separately driven up to by at least one stacker crane so that the latter can store or retrieve a container. The containers are thus received in the rack compartments individually or, in the case of half standard-length containers, at most in pairs, and above the containers there only needs to be sufficient space for operating the transport means of the stacker crane, in particular telescopic systems, with which the containers can be supported suspended and moved perpendicular to the storage aisles into the rack compartments.

The high bay storage system has at least one area which is designed and suitable for receiving empty containers stacked one on top of the other. In this area for empty containers, which is located within the high bay storage system, no separate rack compartments are therefore provided, rather at least one area is provided that does not have the separate rack compartments otherwise provided for the containers. In this at least one area for empty containers, the empty container can be arranged directly stacked straight one on top of the other and can still be reached by means of the stacker cranes. Particularly preferred is a high bay storage system which is designed exclusively for receiving empty containers designed and thus separate rack compartments instead of the storage locations can preferably be entirely dispensed with.

This ensures that, on the one hand, separate stacking areas outside the high bay storage system can be dispensed with and, on the other hand, the handling of empty containers can be carried out automatically, preferably entirely automated, via the stacker cranes within the high bay storage system.

In this connection, preferably the at least one area for empty containers has at least one horizontal row and/or one vertical row of storage locations or partial lengths thereof. It is particularly preferred in this connection for example if the area for empty containers extends above a vertical row of separate rack compartments, or is provided in a plurality of vertical rows above a row of separate rack compartments.

However, it is particularly preferred if the areas for empty container extend on both sides of a storage aisle and the allocated stacker crane is designed exclusively for storing, retrieving and relocating empty containers. In this case, the at least one stacker crane within the storage aisle adjacent to the areas for empty containers can be designed in such a way that it can only move one or, if necessary, several empty containers at a time. This results in a high bay storage system that keeps the use of materials to a minimum and makes optimal use of the means provided for the specific intended use.

It is particularly preferred in this connection if the at least one area for empty containers is dimensioned such that it can receive at least three empty container, preferably more than 15 empty containers, stacked one on top of the other. In high bay storage systems of this type, usually more than 10, preferably 11, separate rack compartments for loaded containers are provided one above the other in each vertical row. Since the space needed for the separate handling of the individual containers must be left in these vertical rows with separate rack compartments between the individual containers, more empty containers of the same height can be provided within a corresponding vertical row of storage locations in an area for empty containers. Since the empty containers can be directly placed straight one on top of the other in this area, optimum use can therefore be made of the corresponding space within the high bay storage system, wherein at least one more container can be received in a vertical row of empty containers than can be received in a vertical row of separate rack compartments that are provided for receiving loaded containers.

It is preferable if the storage locations or separate rack areas are designed and suitable for receiving a 20′ standard container (1 TEU, twenty-foot equivalent unit) or a 40′ standard container (2 TEU) or else for receiving two standard containers of half-length arranged one behind the other in their longitudinal direction. Thus two 20′ standard containers that are end-to-end at their front sides can be stored in a storage location or separate rack compartment which is designed for receiving a 40′ standard container, or two 10′ standard containers (0.5 TEU) can also be stored in a storage location or separate rack compartment which is designed for receiving a 20′ standard container. This results in a high bay storage system which allows the containers to be handled in a fully automated manner while making optimum use of the space.

It is also particularly preferred in this connection if at least two rows of storage locations, preferably rack compartments, are arranged (“double deep”) adjacent to both sides of each storage aisle and stacker cranes can convey the containers into and out of the storage locations, preferably rack compartments, by means of a telescopic system. This special handling and storage of containers has the result that, with a suitable design of the telescopic systems on the stacker cranes, in each case two adjacently arranged storage locations, preferably rack compartments, on each side, and thus a total of four storage locations, preferably rack compartments, can be accessed (“double deep”) from each storage aisle.

The number of storage aisles within such a bay warehouse can thus be reduced further and lead to a high bay storage system that on each side has two horizontal and vertical rows of storage locations, followed by a first storage aisle, then four horizontal and vertical rows of storage locations, followed by a second storage aisle etc. This leads to an optimum use of space within the high bay storage system and the number of storage aisles required for the operation of the high bay storage system can be reduced to the minimum. Designing the high bay storage system as a “double deep” bay warehouse is especially useful when handling empty containers or in some cases containers with just a light load.

It is particularly preferred in this connection if the stacker crane can move the containers with their longitudinal sides aligned parallel to the storage aisles into and out of the storage locations, preferably rack compartments. This means, on the one hand, that the above-described preferred arrangement of two rows of storage locations, preferably rack compartments, on each side of a stacker crane is particularly advantageously supported and, on the other hand, this also results in a minimum width of the storage aisles needed for the stacker cranes.

The empty containers are directly stacked straight one on top of the other in a different way to the loaded containers; however due to the corner regions of the containers, the so-called “corner castings”, being unsteady, the stack can become unstable as the stack height increases, which in the worst-case scenario can result in the entire stack or parts thereof tipping over, possibly into the travel aisle of the stacker crane. To overcome this problem, retaining means can be provided on the high bay storage system itself, which in a particularly preferred embodiment of the invention are attached at regular intervals preferably to both sides of the stack or the areas for empty containers. It is especially preferred if such retaining means are horizontally arranged struts which are attached to the vertical uprights of the high bay storage system.

In this connection, it is particularly preferred if these retaining means, particularly in the form of horizontal struts, are chamfered on the top and bottom, so that the handling of the empty containers, which have to be lifted away from the retaining means during storing or retrieving, is only minimally restricted and without the risk of damaging the empty containers.

Preferably, at least one storage aisle is arranged adjacent to two rows of areas for empty containers on each side and the stacker cranes can convey the empty containers into and out of the areas for empty containers by means of a telescopic system. This leads to a high bay storage system, which, with optimal use of space, applies the same system used to handle loaded containers to the area for empty containers. This assists with both the safe operation of the high bay storage system and the degree of automation of the handling of both loaded and empty containers.

It is particularly preferred in this connection if the high bay storage system is designed such that it can store more than 2500 standard containers pro ha (2500 TEU/ha), preferably more than 3000 TEU/ha, very preferably more than 5000 TEU/ha. The unit TEU/ha shown here represents a measure used in the industry for the capacity of port logistics and in particular of high bay storage systems. The above-described stacking areas for empty containers outside high bay storage systems and the operation with vehicles provided specifically for this purpose, for instance reach stackers, ECHs or the like, achieves a space utilization of no more than 2500 TEU/ha. The high bay storage system according to the invention is able to increase the area beyond this known extent for the handling of both loaded and empty containers in a preferably fully automated manner.

According to a further aspect, a method is provided for storing and retrieving or relocating containers in a high bay storage system according to the above-described first aspect of the invention. Within this high bay storage system, the loaded containers are picked up by means of the stacker cranes, transported to the respective rack compartments and are stored therein or else, in the case of empty containers, are stored in an area within the high bay storage system which is designed and suitable for receiving empty containers stacked one on top of the other.

The containers, both the loaded and the empty containers, are preferably transported within the high bay storage system fully automatically. Empty containers are preferably arranged stacked one on top of the other within the high bay storage system in areas provided therefor, preferably in vertical rows or horizontal rows of the high bay storage system or else of parts of these rows, with optimum utilization of space, where the empty containers are taken from the top of the respective stack or placed on top of existing stacks of empty containers in these areas.

It is particularly preferred in this connection if groups of empty containers, preferably three empty containers stacked one above the other and connected to one another, are picked up by means of a stacker crane, moved together within the high bay storage system, and conveyed into or out of the area for empty containers.

It can also be preferable to provide horizontal crossbeams in the area for the empty containers, via which these areas can be divided into at least two stacking areas for empty containers. This can reduce the stacking height for empty containers using simple means without significantly affecting the receiving capacity of these areas.

### BRIEF DESCRIPTION OF THE DRAWINGS

The invention is explained in more detail hereinbelow with reference to three figures, which show preferred embodiments. The figures are not intended to limit the scope of protection of the invention.

FIG. 1 shows a sectioned side view of a high bay storage system, which is designed exclusively for storing empty containers.

FIG. 2 shows a view from above of a high bay storage system, which is designed exclusively for storing empty containers.

FIG. 3 shows a sectioned view of the front side of a high bay storage system, which is designed exclusively for storing empty containers.

FIG. 4 shows a sectioned view of the front side of a high bay storage system, which is designed for storing both loaded and empty containers.

### DETAILED DESCRIPTION

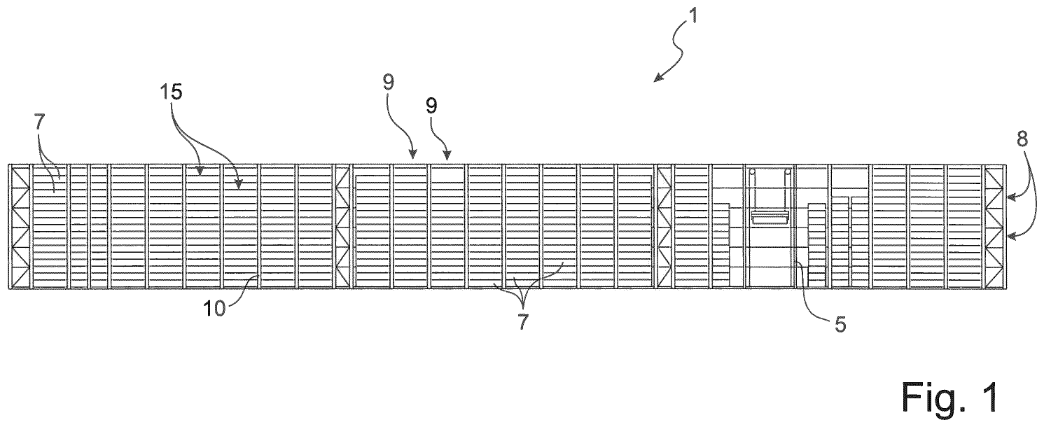

FIG. 1 shows a sectioned side view of a high bay storage system 1 having a plurality of vertical rows 9 and horizontal rows 8 of storage locations 15 for empty containers 7. Behind the shown area of vertical rows 9 and horizontal rows 8 for empty containers 7, a stacker crane 5 is arranged in a storage aisle (not shown), which stacker crane can move empty containers 7 from left to right and from top to bottom or in the opposite direction within the high bay storage system 1 and store them in and retrieve them from the respective storage locations 15. The empty containers 7 can be arranged in the vertical rows 9 shown here directly stacked straight one on top of the other without any space between them. The stacker crane 5 is able to access any position within the rows 6a, 6b for empty containers 7, and empty containers 7 are regularly stored starting from the bottom and retrieved staring from the top. Should individual or all vertical rows 9 have horizontally extending intermediate shelves (not shown), multiple stacks of empty containers can be formed in each row 9 and extended separately by the stacker crane 5.

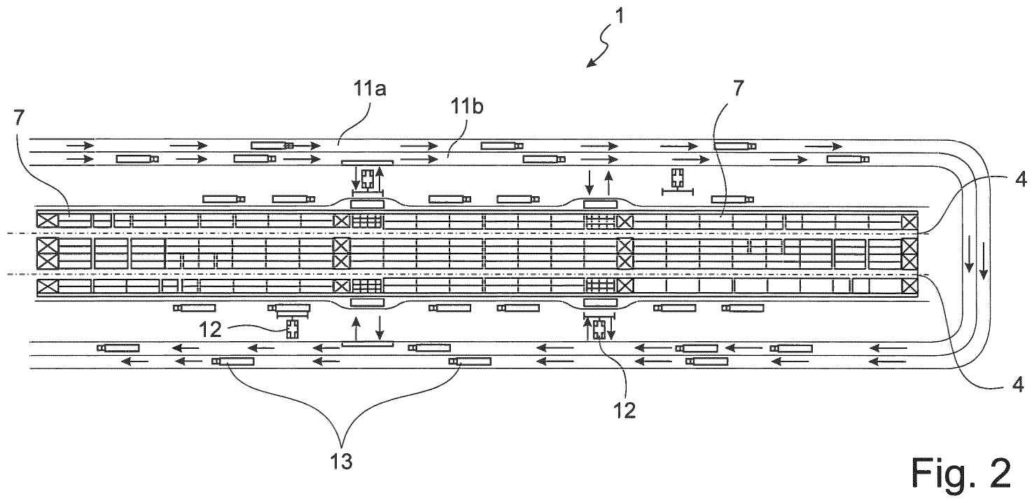

FIG. 2 shows a plan view from above of the high bay storage system 1 according to the invention from FIG. 1. The high bay storage system 1 is surrounded by transport paths 11a, 11b, via which empty containers 7 can be transported to and away from the high bay storage system 1. The transfer of empty containers 7 from the transport paths 11a, 11b into the high bay storage system 1 is carried out using suitable transport devices 12, which are designed and configured to swap empty containers 7 between the transport paths 11a, 11b and the high bay storage system 1 and in the case of storing empty containers 7 to pick these up from the vehicles 13 and to convey them into the area of stacker cranes (not shown) within the storage aisles 4. There, the empty containers 7 are taken up by stacker cranes (not shown) which are movably arranged in the storage aisles 4 and are then conveyed by said stacker cranes to a suitable storage location 15 within the high bay storage system 1.

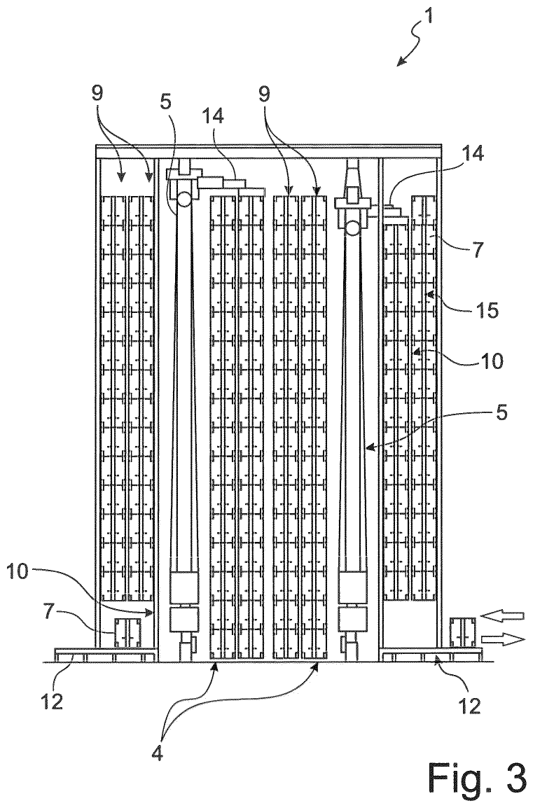

FIG. 3 shows a sectioned front view of a high bay storage system 1 according to the invention, in which it can be seen that each storage aisle 4 and the stacker crane 5 arranged there in each case are assigned two vertical rows 9 of storage locations 15 arranged adjacent to each side. This arrangement of empty containers 7 within a high bay storage system 1 that is referred to as “double deep stacking” is made possible by the fact that each stacker crane 5 is assigned a telescopic system 14, by means of which the respective empty containers 7 can be conveyed suspended in any position within the vertical rows 9 and into any storage location 15. In the case shown here, this leads (viewed from left to right) to an arrangement of two lateral vertical rows 9, followed by a storage aisle 4 with stacker crane 5, then four vertical rows 9 of storage locations 15, followed once more by a storage aisle 4 with a corresponding stacker crane 5 on the opposite side, and finally followed again by rows 9 of storage locations 15 arranged one above the other. In the lower level of the high bay storage system 1, empty containers 7, which were removed by vehicles (not shown) from the transport paths (not shown), are conveyed by means of a transport device 12 into the area of the high bay storage system 1 in order to then be able to be picked up by the respectively assigned stacker crane 5. If empty containers 7 are being retrieved from the high bay storage system 1, an empty container 7 is removed from the respective storage location 15 in the opposite way and the corresponding empty container 7 is placed on the transport device 12, in order to then be conveyed out of the high bay storage system 1 by this transport device 12.

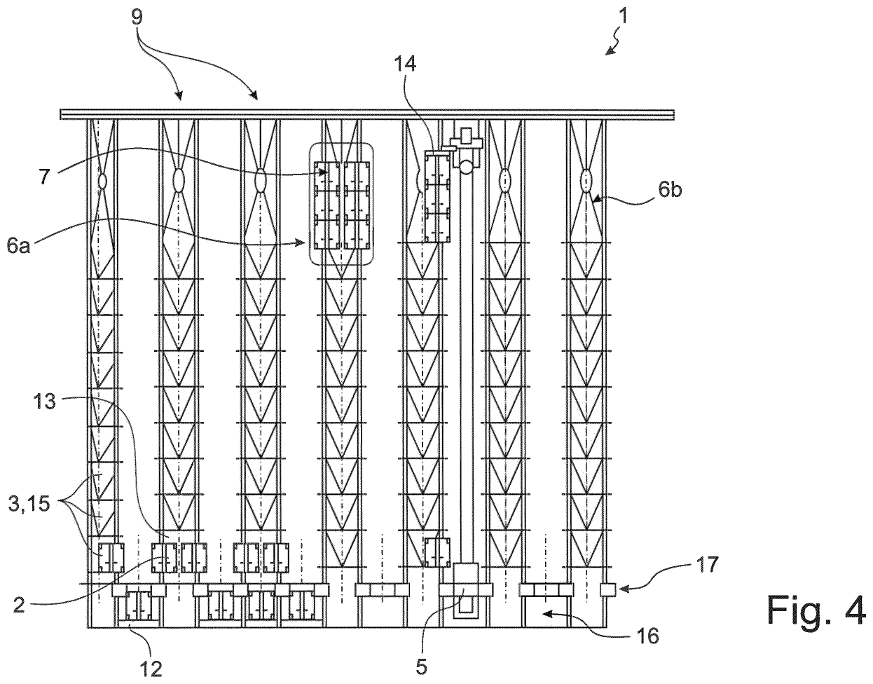

FIG. 4 shows a sectioned view of a front side of high bay storage system 1 according to the invention, having the sequence of in each case of a vertical row 9 of separate rack compartments 3 for loaded containers 2 and a storage aisle 4, in which at least one stacker crane 5 is arranged in each case. While each separate rack compartment 3 has a sufficient space 13 for the telescopic system 14 of each stacker crane 5 to reach into, the respective upper areas 6a, 6b of each vertical row 9 are designed such that at least three storage locations 15 for empty containers 7 are provided arranged one above the other. These empty containers 7 can be arranged in the areas 6a, 6b directly stacked straight one on top of the other and grasped starting from the bottom and moving to the by the telescopic system 14 of the stacker crane 5 and also removed from the areas 6a, 6b again from top to bottom. In the present embodiment, the loaded containers 2 and empty containers 7 are supplied to the high bay storage system 1 via a transport level 16 arranged below the level of the lowermost rack compartments 3 with transport devices 12 or transport paths 11 that are provided there so that a suitable means of transport such as a lorry (not shown) can access a position below the stacker crane 5. The loaded containers 2 or empty containers 7 are then removed by the lorry (not shown) or the transport device 12 below the driving level 17 for the stacker cranes 5 and lifted vertically upwards next to a corresponding rack compartment 3 or next to the area 6a, 6b for empty containers 7. The loaded containers 2 are then laterally guided into the corresponding rack compartments 3 by means of the telescopic system 14, or empty containers 7 are placed in the area 6a, 6b, possibly placed on top of empty containers 7 that are already there.

### LIST OF REFERENCE NUMERALS

1 high bay storage system
2 container
3 rack compartments
4 storage aisle
5 stacker crane
6a area for empty containers
6b area for empty containers
7 empty containers
8 horizontal row
9 vertical row
10 vertical pillar
11a transport path
11b transport path
12 transport device
13 space for telescopic system
14 telescopic system
15 storage location
16 transport plane
17 driving level for stacker crane

1.-19. (canceled)

20. A high bay storage system (1) for storing and retrieving containers (2), comprising:
a plurality of storage locations (15) arranged horizontally next to one another and vertically one above another for containers (2); and
storage aisles (4) which are arranged between groups of the storage locations (15) and extend in parallel with one another;
stacker cranes (5), including at least one stacker crane (5) arranged in each of the storage aisles (4) so as to be moveable back and forth, the stacker crane (5) being designed to move the containers (2) vertically and horizontally and into and out of the storage locations (15); and
at least one area (6) for empty containers (7) designed and suitable for receiving empty containers (7) stacked one on top of another.

21. The high bay storage system (1) according to claim 20,
wherein at least some of the storage locations (15) comprise separate rack compartments (3).

22. The high bay storage system (1) according to claim 20,
wherein the at least one area (6) for empty containers (7) has dimensions of at least one horizontal row (8) and/or one vertical row (9) of storage locations (15) or separate rack compartments (3) or part lengths thereof.

23. The high bay storage system (1) according to claim 22,
wherein the at least one area (6) for empty containers (7) is dimensioned such that it can receive at least three empty containers (7) stacked one on top of another.

24. The high bay storage system (1) according to claim 20,
wherein the high bay storage system (1) is designed to exclusively receive empty containers (7).

25. The high bay storage system (1) according to claim 20,
comprising more than ten separate rack compartments (3) arranged vertically one above another in vertical rows (9).

26. The high bay storage system (1) according to claim 20,
wherein vertical rows (9) of storage locations (15) can receive more than fourteen empty containers (7).

27. The high bay storage system (1) according to claim 20,
wherein the storage locations (15) are designed and suitable for receiving
a 20-foot standard container,
a 40-foot standard container,
two 10-foot standard containers arranged one behind another in their longitudinal direction, or
two 20-foot standard containers arranged one behind another in their longitudinal direction.

28. The high bay storage system (1) according to claim 20,
wherein the storage aisles (4) are arranged on both sides adjacent in each case to at least two rows (9a, 9b) of storage locations (15), and
wherein the stacker cranes (5) can convey the containers (2, 7) into and out of the storage locations (15) by a telescopic system.

29. The high bay storage system (2) according to claim 20,
wherein the stacker cranes (5) can move the containers (2, 7) into and out of the storage locations (15) with longitudinal sides of the containers (2, 7) being aligned parallel to the storage aisles (4).

30. The high bay storage system (1) according to claim 20,
wherein the stacker cranes (5) can transport the containers (2, 7) suspended and supported from above.

31. The high bay storage system (1) according to claim 25,
wherein each rack compartment (3) has supports at least for lower corners of the containers (2).

32. The high bay storage system (1) according to claim 20,
wherein at least one of the storage aisles (4) is arranged adjacent to two rows of areas (6a, 6b) for empty containers (7) on each side and
wherein the stacker cranes (5) can convey the empty containers (7) into and out of the area (6) for empty containers (7) by a telescopic system.

33. The high bay storage system (1) according to claim 20,
wherein the high bay storage system (1) in the designed and suitable for transshipping more than 2500 TEU/ha.

34. The high bay storage system (1) according to claim 20,
wherein high bay storage system (1) is part of a transshipment facility.

35. A method for storing and retrieving or relocating a container (2) in the high bay storage system (1) according to claim 20, comprising:
picking up the container (2) by the stacker cranes (5);
transporting the container (2) to a respective storage location (15) and storing the container (2) therein or, in case the container (2) is an empty containers (7), storing the container (2) in an area (6) which is designed and suitable for receiving empty containers (7) stacked one on top of another.

36. The method according to claim 35,
wherein the container (2) is stored in and moved out of the respective storage location (15), and stored in and moved out of the area (6) for empty containers (7) with a longitudinal side parallel to the storage aisles (4).

37. The method according to one of claim 35,
wherein the container (2, 7) is transported within the high bay storage system (1) fully automatically.

38. The method according to claim 35, further comprising:
stacking a group of three empty containers (7) on top of one another and connecting the three empty containers (7) to one another,
picking up the group of three empty containers (7) by a stacker crane (5), moving the group of three empty containers (7) together within the high bay storage system (1), and
conveyed the group of three empty containers (7) into or out of the area (6) for empty containers (7).
